(19) United States
(12) Patent Application Publication
(10) Pub. No.: US 2013/0330687 A1
(43) Pub. Date: Dec. 12, 2013

(54) INTERFACE STRUCTURE FOR LIQUID/AIR BURST DENTAL CLEANING APPLIANCE

(71) Applicants: Dainia Edwards, Issaquah, WA (US); Evert Alle Helfrich, Seattle, WA (US); Matthew Laurence Arksey, Seattle, WA (US); Ian Estle Graves, Seattle, WA (US)

(72) Inventors: Dainia Edwards, Issaquah, WA (US); Evert Alle Helfrich, Seattle, WA (US); Matthew Laurence Arksey, Seattle, WA (US); Ian Estle Graves, Seattle, WA (US)

(73) Assignee: KONINKLIJKE PHILIPS N.V., EINDHOVEN (NL)

(21) Appl. No.: 14/001,080

(22) PCT Filed: Feb. 21, 2012
(86) PCT No.: PCT/IB2012/050781

§ 371 Date: Aug. 22, 2013

Related U.S. Application Data
(60) Provisional application No. 61/447,367, filed on Feb. 28, 2011.

(51) Int. Cl. A61C 17/02; A61C 17/022

(52) U.S. Cl. CPC A61C 17/0202; A61C 17/022
USPC 433/89

(57) ABSTRACT

The power dental appliance includes a handle/receiver assembly (12) and a nozzle assembly (14) which is attachable thereto. The nozzle assembly and the handle/receiver include portions which together define an interface arrangement. The nozzle includes an extending tubular member (30), with two sets of opposing sides with lateral grooves (42, 44) in one set of opposing sides (38, 40), near the lower end thereof. The handle/receiver includes a hollow upper portion (32), into which the tubular member portion of the nozzle fits, the hollow portion including mating projections in the form of ribs (46, 48) which mate with the grooves in the tubular member to prevent the nozzle from coming off the handle during operation of the appliance, but permitting removal thereof by the user.

This invention relates generally to dental appliances using liquid/air mixture bursts for dental cleaning, and more specifically concerns an interface structure between the nozzle and handle portions of the appliance.

Dental appliances for cleaning teeth, such as those using successive bursts of a liquid/air mixture, typically include a handle/receiver portion which includes the system for producing the liquid/air bursts and an extending nozzle portion through which the liquid/air bursts are directed to the teeth. The extending nozzle portion is separable from the handle/receiver so that replacement of the nozzle from time to time is convenient for the user. The interface between the handle/receiver and the nozzle is important, as it must be able to provide a secure attachment between those two members, preventing escape of the nozzle during operation, while being convenient for the user to remove and replace. Furthermore, the interface should provide a secure fit between the two members to prevent rocking of the nozzle from side to side during operation of the appliance, even though the nozzle may be securely positioned on the handle/receiver.

Accordingly, the dental appliance comprises: a handle/receiver assembly, including a system for producing a stream of liquid/air bursts; a nozzle assembly, through which the bursts of liquid/air are directed, the nozzle assembly including an exit member (20) for directing the liquid/air bursts to selected dental regions, wherein the nozzle assembly and handle/receiver include a combined interface arrangement, the nozzle including an extending tubular member and the handle/receiver including an opening defined by an interior wall at an upper end thereof, the tubular member having two sets of opposing side surfaces, wherein one set of side surfaces includes a lateral groove or angled surface or finger member and the handle/receiver includes a mating lateral projection from the interior walls thereof, configured to mate together so as to prevent the nozzle member from coming off the handle/receiver during operation of the appliance, but permitting convenient pull-off thereof by the user for replacement thereof.

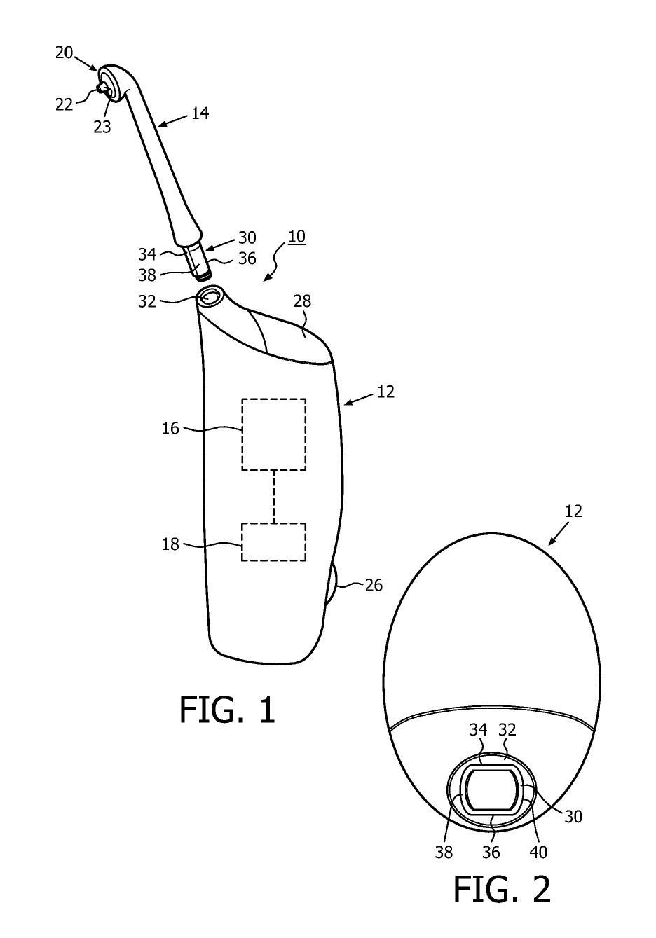

FIG. 1 is an exploded view showing a nozzle and a handle/receiver for a dental cleaning appliance using successive bursts of a liquid/air mixture.

FIG. 2 is a lateral cross-sectional view showing the interface connection between the nozzle and the handle/receiver.

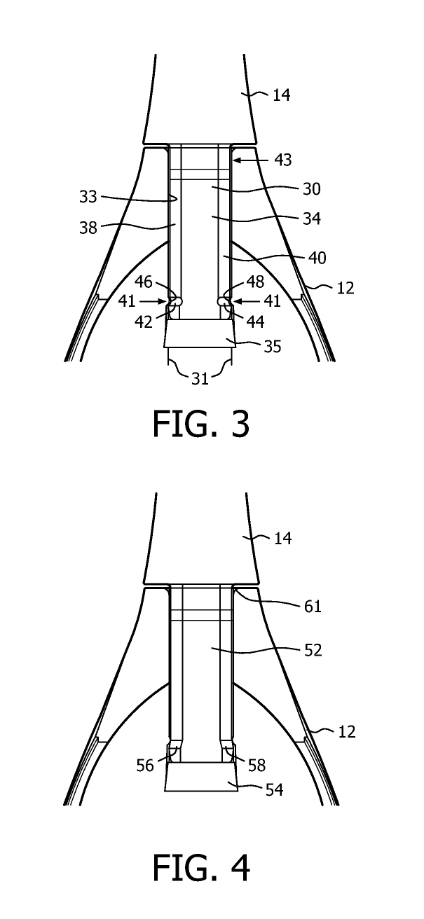

FIG. 3 is a vertical cross-sectional view showing one embodiment of the interface structure for the appliance of FIG. 1.

FIG. 4 is a vertical cross-sectional view of another embodiment of the interface structure.

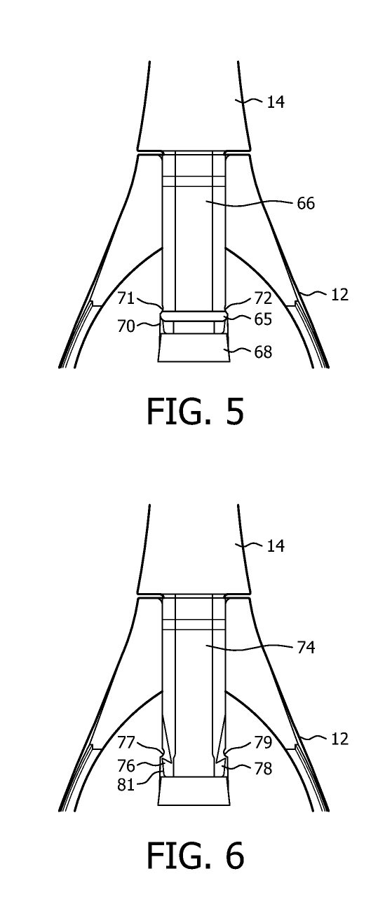

FIG. 5 is a vertical cross-sectional view of another embodiment of the interface structure.

FIG. 6 is a vertical cross-sectional view of still another embodiment of the interface structure.

FIG. 1 shows a dental cleaning appliance at 10. The appliance 10 in operation produces successive bursts of a liquid/air mixture. The succession (stream) of bursts is useful in cleaning the dental regions of a user, particularly the interproximal and gingival areas. With respect to the interproximal areas, it has potentially a beneficial effect somewhat similar to flossing. For those users who have difficulty flossing on a regular basis, the cleaning appliance of FIG. 1 provides a reasonably effective alternative.

The appliance includes a handle/receiver portion 12 and an extending nozzle portion 14. Located in the handle/receiver portion 14 is a liquid/air mixture burst-generating system 16, and a power source 18 therefor, such as rechargeable batteries. A detailed explanation of one such system is described in pending patent application Ser. No. 61/387,527, owned by the assignee of the present application, the contents of which are incorporated by reference herein. Nozzle 14 extends away from the handle and is relatively slim, in order to conveniently fit into the mouth of a user, for reaching all of the interproximal and gingival areas of the teeth. The nozzle terminates in an exit member 20 having a small opening 22 in a forwardly extending portion 23, through which the successive bursts of liquid/air mixture are directed to the teeth. The opening in the embodiment shown is approximately 1 mm in diameter, although this can be varied. Further, exit member 20 has a surface configuration to facilitate proper contact and placement of the exit member in the interproximal areas of the teeth. The handle/receiver also includes an on/off switch 26 and a control member 28 which when operated by the user produces the bursts of liquid/air mixture. While the liquid will frequently will be water, it should be understood that other liquids, such as mouthwash and medications, can also be utilized.

Nozzle 14 is removable from the receiver/handle so that it can be conveniently replaced and/or cleaned as necessary. The following portion of the application concerns various embodiments of the interface between the nozzle and the handle/receiver. While the interface is certainly useful on the dental appliance described above, it should be understood that such an interface can also be used on other personal care appliance, particularly those which use some form of a liquid/air stream or droplets.

FIGS. 1-3 show one embodiment of such an interface. The embodiment includes a tubular member 30 which extends down into an opening 32 at the upper end of the handle/receiver. Opening 32 is defined by a wall 33; at the bottom of opening 32 is a seal member 35. In the embodiment shown, the tubular member includes two sets of opposing sides. The sides 34, 36 comprising one set are flat and basically are parallel to each other. The sides 38, 40 in the other set are slightly curved. This arrangement ensures that the nozzle is inserted in proper alignment with the opening in the handle, and that the exit member faces in proper direction for use, as shown in FIG. 1. Tubular member 30 is hollow to permit movement of liquid/air therethrough into the nozzle 14. Near the lower end of tubular member 30 are two grooves 42 and 44 in opposing sides 38 and 40. The lower edges of grooves 42 and 44 are typically sharp so as to provide a good contact between mating protrusions on the inner surface of the handle/receiver. In the embodiment of FIG. 3, the protrusions include rib elements 46 and 48 which extend a small distance into the opening 32 in the handle/receiver. When the nozzle is firmly inserted into the handle, ribs 46 and 48 seat within the grooves 42 and 44, with the lower edge of the grooves, making a sealing contact with ribs 46 and 48.

Although the embodiment shows ribs on both sides of the opening, a rib on only one side can produce satisfactory results. Furthermore, the ribs need not be continuous. Sufficient contact must be made, however, to prevent the nozzle from coming off the handle during operation.

The interface fit between the width 39 of the nozzle and the width 41 of the receiver ribs will range from 0.05 mm to 0.5 mm. Further, when the nozzle is operatively positioned in the handle, there is an interference fit/contact between the lower end of the tubular member 30 and the seal 35 which ranges from 0.1 mm to 0.2 mm Further, there is a fit at 43 between the upper end of the tubular member and the upper end of the handle opening in the range of −0.2 mm (clearance) and 0.2 mm (interference).

FIG. 4 shows a variation of FIG. 3 in which the tubular member 52 of the nozzle extends down into an opening in the handle/receiver to a sealing member 54. At the lower end of the tubular member, however, instead of grooves, are shown downwardly and outwardly angled portions 56 and 58 which extend outwardly slightly beyond the remaining outer surface of the tubular member above the angled portions. When the nozzle is firmly inserted into the handle, the angled portions 56 and 58 provide an interference fit against the ribs 58 and 60 on the handle/receiver, providing the required function of maintaining the nozzle within the handle during operation, while permitting the nozzle to be conveniently removed by the user when necessary. This embodiment also includes an interference fit at or near the upper end of the interface so as to prevent rocking or other movement between the nozzle and the handle/receiver during operation.

FIG. 5 shows a further embodiment, in which the structure and configuration of the interface assembly are generally similar to the embodiments of FIGS. 3 and 4. In FIG. 5 is an O-ring 65 positioned at the lower end of the tubular member 66. The O-ring 65 is positioned in a groove surrounding the tubular member which extends to seal 68. When the nozzle is firmly inserted into the opening 70 in the handle/receiver, the O-ring 65 is positioned below projections 71 and 72 in the interior wall of the opening in the handle, thereby maintaining the nozzle securely on the handle/receiver during operation.

FIG. 6 shows a still further embodiment of the interface assembly, in which the lower end of the tubular member 74 includes angled fingers 76 and 78, configured to be somewhat bendable under pressure inwardly, to clear the projections 77 and 79 on the interior wall of the opening 81 in the handle/receiver. In particular, fingers 76 and 78 have an angular arrangement such that there is a space between the free outer ends of the fingers and a slanted surface portion of the tubular member. In this arrangement, the angled fingers bend inwardly under downward pressure as the nozzle is pressed into the handle, permitting the fingers to pass below projections 77 and 79. At that point, the angled fingers will spring back, thereby preventing the nozzle from coming off the handle during operation, but such that the nozzle can be removed from the handle by the user.

As an alternative, the projections can be present in the tubular member portion of the nozzle and the bendable fingers can be used on the interior wall of the opening in the handle/receiver.

Hence, a number of embodiments have been disclosed to illustrate the present invention involving an interface connection between a nozzle and a handle/receiver in a dental cleaning appliance, which typically, but not necessarily, provides a stream of successive bursts of liquid and air mixture for cleaning of the teeth, in particular the interproximal areas of the teeth.

Although a preferred embodiment has been disclosed for purposes of illustration, it should be understood that various changes and modifications and substitutions could be made in the preferred embodiment without departing from the spirit of the invention as defined by the claims which follow:

1. A power dental appliance for cleaning teeth, comprising:
a handle/receiver assembly, including a system for producing a stream of liquid/air bursts;
a nozzle assembly, through which the bursts of liquid/air are directed, the nozzle assembly including an exit member for directing the liquid/air bursts to selected dental regions, wherein the nozzle assembly and handle/receiver include a combined interface arrangement, the nozzle including an extending tubular member and the handle/receiver including an opening defined by an interior wall at an upper end thereof, the tubular member having two sets of opposing side surfaces, the interior wall of the handle/receiver having corresponding side surfaces, wherein two opposing sides in one set of side surfaces are slightly curved and wherein two opposing sides in the other set of side surfaces are flat and are parallel with each other, wherein one set of side surfaces includes a lateral groove or angled surface or finger member in the vicinity of the lower end thereof and the handle/receiver includes a mating lateral projection from the interior wall thereof, configured to mate together so as to prevent the nozzle member from coming off the handle/receiver during operation of the appliance, but permitting convenient pull-off thereof by the user for replacement thereof.

2. The dental appliance of claim 1, wherein the tubular member and the handle/receiver are arranged to provide an interference fit where they come adjacent to each other to prevent rocking of the nozzle during operation of the appliance.

3. The dental appliance of claim 1, including a groove or finger member in both side surfaces of said one set and mating projections in the form of ribs in the opening of the handle/receiver.

4. The dental appliance of claim 1, wherein the tubular member extends into the opening in the handle/receiver to contact a sealing member therein.

5. The dental appliance of claim 3, wherein the two rib members are positioned 180° from each other.

6. (canceled)

7. The dental appliance of claim 1, including an O-ring positioned laterally around the tubular member in the lower end thereof, providing a mating arrangement with the projections in the form of ribs, from the interior wall of the opening of the handle/receiver.

8. The dental appliance of claim 1, wherein the combined interference arrangement includes projections, in the form of ribs, from the interior wall of the opening in the handle/receiver. and spring fingers extending outwardly from the tubular member, wherein pressure exerted in moving the nozzle into the handle moves the spring fingers inwardly so that they move past the ribs, at which point the fingers spring back, providing a mating arrangement with the projections in the handle/receiver, preventing the nozzle from coming off during operation.
